(19) United States
(12) Patent Application Publication
(10) Pub. No.: US 2023/0290544 A1
(43) Pub. Date: Sep. 14, 2023

(54) SYSTEMS AND METHODS FOR MANUFACTURE OF FLEXIBLE SHIELDED RIBBON CABLES

(71) Applicant: Maybell Quantum Industries, Inc., Denver, CO (US)

(72) Inventors: Corban I. Tillemann-Dick, Denver, CO (US); Kyle J. Thompson, Boulder, CO (US); Bryan J. Choo, New York, NY (US); Johanna Zultak, Boulder, CO (US); Jonathan Michael Byars, Golden, CO (US)

(73) Assignee: Maybell Quantum Industries, Inc., Denver, CO (US)

(21) Appl. No.: 18/182,244

(22) Filed: Mar. 10, 2023

Related U.S. Application Data
(60) Provisional application No. 63/319,225, filed on Mar. 11, 2022.

(51) Int. Cl. H01B 13/00; H01B 7/04; H01B 7/08; B23K 3/08; B23K 1/00

(52) U.S. Cl. CPC H01B 13/0036; H01B 7/04; H01B 7/0823; B23K 3/08; B23K 1/0008; B23K 2101/38

(57) ABSTRACT

Provided herein are systems and methods for manufacturing a cable. In some embodiments, a system for manufacturing a cable includes a joining mechanism configured to join the upper conducting foil and the lower conducting foil; and a linear actuator configured to control motion of the joining mechanism with respect to the upper conducting foil and the lower conducting foil. In some embodiments, a system for manufacturing a cable includes: an electrode configured to join the upper conducting foil and the lower conducting foil in a region between insulated conductors of the plurality of insulated conductors; and a plurality of rollers configured to position the upper conducting foil, the lower conducting foil, and the plurality of insulated conductors relative to the electrode.

### CROSS-REFERENCE TO RELATED APPLICATIONS

This application claims the benefit under 35 U.S.C. § 119(e) of U.S. Provisional Patent Application No. 63/319,225 filed on Mar. 11, 2022, entitled “SYSTEMS AND METHODS FOR MANUFACTURE OF FLEXIBLE COAXIAL RIBBON CABLE FOR LOW TEMPERATURE APPLICATIONS,” the entire contents of which is incorporated by reference herein in its entirety.

### BACKGROUND

Flexible shielded ribbon cables are formed of one or more inner conductors separated from an outer conductor by an insulating layer. Flexible shielded ribbon cables are used to transport signals in high precision electronics, components, and devices.

### SUMMARY

Some embodiments provide for a system for joining an upper conducting foil and a lower conducting foil. In some embodiments, the system includes a joining mechanism configured to join the upper conducting foil and the lower conducting foil and a linear actuator configured to control motion of the joining mechanism with respect to the upper conducting foil and the lower conducting foil.

Some embodiments provide for a method for joining an upper conducting foil and a lower conducting foil, the method comprising: using a linear actuator to control motion of a joining mechanism with respect to the upper conducting foil and the lower conducting foil; and joining the upper conducting foil and the lower conducting foil using the joining mechanism.

Some embodiments provide for a system for manufacturing a cable comprising a plurality of insulated conductors positioned between an upper conducting foil and a lower conducting foil. In some embodiments, the system includes an electrode configured to join the upper conducting foil and the lower conducting foil in a region between insulated conductors of the plurality of insulated conductors and a plurality of rollers configured to position the upper conducting foil, the lower conducting foil, and the plurality of insulated conductors relative to the electrode.

Some embodiments provide for a method for manufacturing a cable comprising a plurality of insulated conductors positioned between an upper conducting foil and a lower conducting foil, the method comprising: using an electrode to join the upper conducting foil and the lower conducting foil in a region between insulated conductors of the plurality of insulated conductors; and using a plurality of rollers to position the upper conducting foil, the lower conducting foil, and the plurality of insulated conductors relative to the electrode.

Some embodiments provide for a method for manufacturing a cable comprising a plurality of insulated conductors and a conducting foil. In some embodiments, the method includes positioning the plurality of insulated conductors over the conducting foil, applying pressure to the plurality of insulated conductors to deform the conducting foil, and forming a cable using the deformed conducting foil.

Some embodiments provide for a system for aligning a plurality of conductors. In some embodiments, the system includes a first plurality of posts positioned in a first region and a second plurality of posts positioned in a second region. In some embodiments, the first plurality of posts and the second plurality of posts are configured to align the plurality of conductors between the first region and the second region.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1A is a schematic diagram of a flexible shielded ribbon cable, in accordance with some embodiments of the technology described herein.

FIG. 1B is a schematic diagram of a flexible shielded ribbon cable, in accordance with some embodiments of the technology described herein.

FIG. 1C is a schematic diagram of a dilution refrigerator including flexible shielded ribbon cables, in accordance with some embodiments of the technology described herein.

FIG. 2 is a flowchart of a method 200 for manufacturing a cable, in accordance with some embodiments of the technology described herein.

FIG. 3A and FIG. 3B are schematic diagrams of a system 300 for aligning conductors, in accordance with some embodiments of the technology described herein.

FIG. 4A is a schematic diagram of a system 400 for deforming a conducting foil, in accordance with some embodiments of the technology described herein.

FIG. 4B is a schematic diagram of a system for manufacturing a cable using the deformed conducting foil, in accordance with some embodiments of the technology described herein.

FIG. 5 is a schematic diagram of a system 500 for joining layers of conducting foil, in accordance with some embodiments of the technology described herein.

FIG. 6A is a schematic diagram of a roll-to-roll system 600 for joining layers of conducting foil, in accordance with some embodiments of the technology described herein.

FIG. 6B is a schematic diagram of an example cross section of the roll-to-roll system 600 of FIG. 6A, in accordance with some embodiments of the technology described herein.

FIG. 7A and FIG. 7B are schematic diagrams of a method for back filling a cable, in accordance with some embodiments of the technology described herein.

### DETAILED DESCRIPTION

High precision electronics, components, and detectors often require shielded electrical interconnects that transport signals between signal generation and detection or utilization with controlled attenuation, controlled impedance, minimized reflection, minimal cross talk between signal lines, and minimized thermal conduction. Creating interconnects to maximize signal density and signal quality, while minimizing physical space usage and thermal load, represents a significant challenge.

Flexible shielded ribbon cables show potential for addressing these challenges. However, due to the manual, labor intensive, and inexact process for conventionally manufacturing shielded and flexible ribbon cables, high volume production is inefficient and there are inconsistencies and inefficiencies associated with the resulting cables. The inventors have thus recognized that using manufacturing techniques that are automated, exact, and less labor intensive will increase production efficiency and will produce cables that overcome the limitations of cables produced using the conventional manufacturing techniques.

I. Flexible Shielded Ribbon Cables

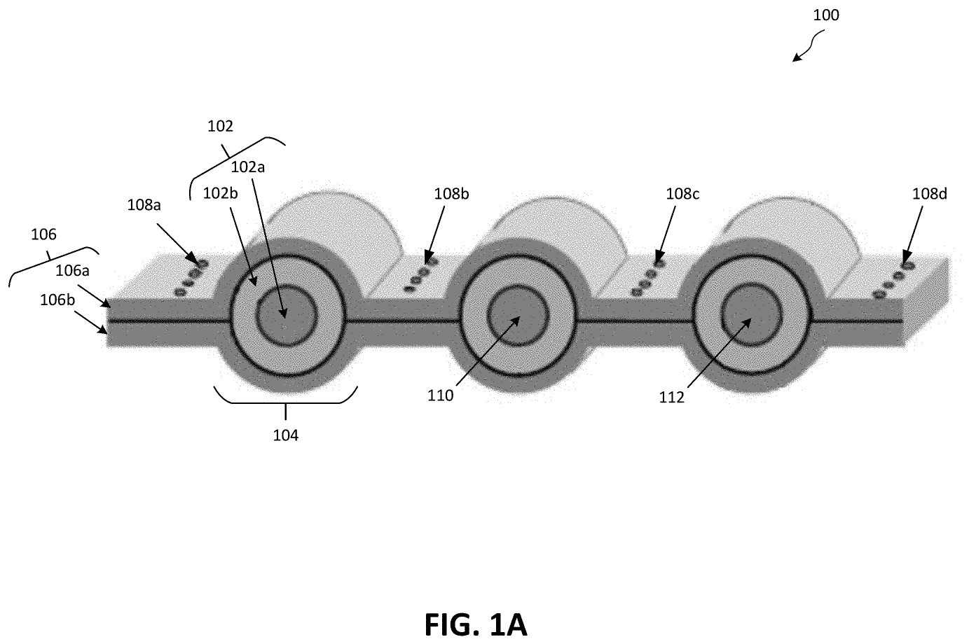

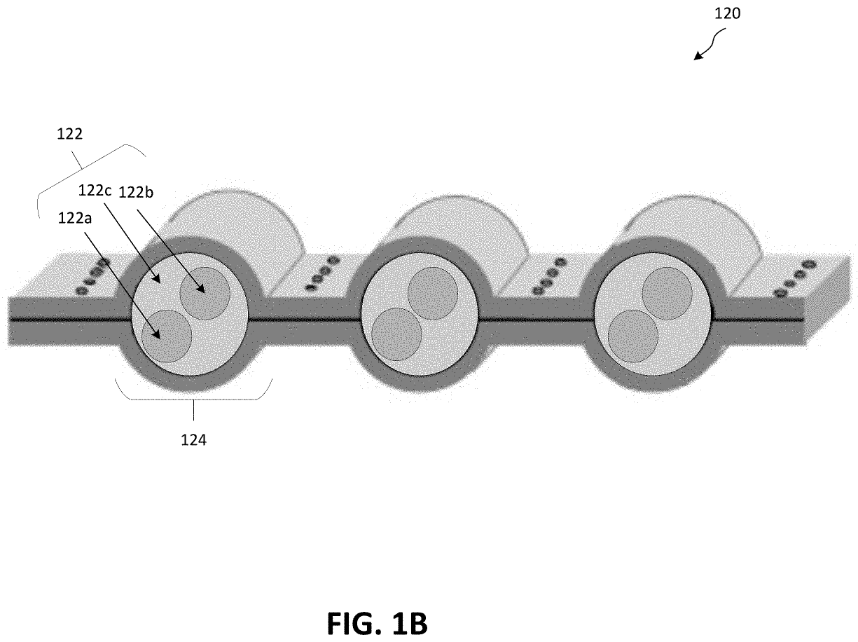

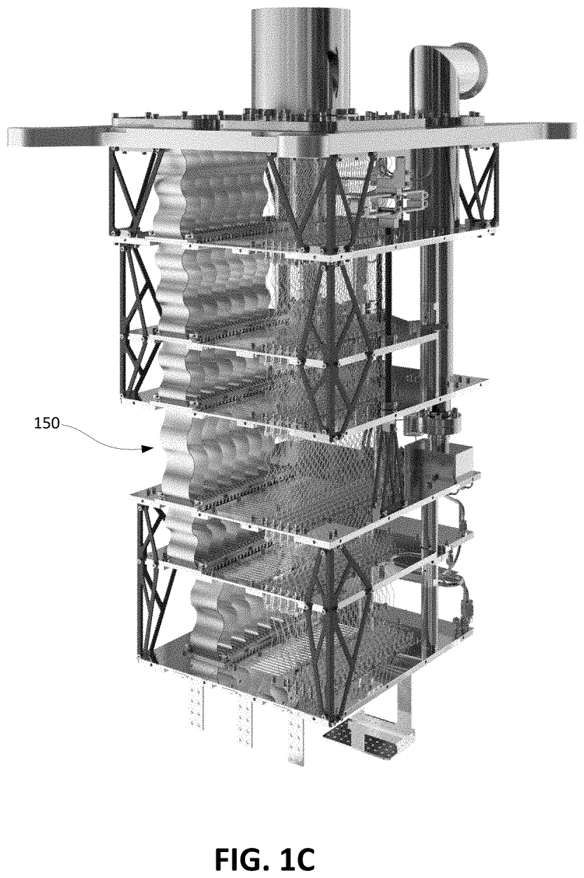

FIG. 1A is a schematic diagram of a flexible shielded ribbon cable 100, in accordance with some embodiments of the technology described herein. In some embodiments, flexible shielded ribbon cable 100 includes one or more insulated conductors 102 positioned between an upper conducting foil 106a and a lower conducting foil 106b. In some embodiments, the upper conducting foil 106a and the lower conducting foil 106b are joined in regions 108a-d along the length of each insulated conductor 102.

In some embodiments, an insulated conductor 102 includes conductor 102a. The conductor 102a may be composed of any suitable conducting or superconducting material, such as, for example, niobium-titanium (NbTi), copper-nickel (CuNi), beryllium-copper (BeCu), copper (Cu), or stainless steel. In some embodiments, the conductor 102a has a diameter between 0.05 mm and 0.1 mm, 0.06 mm and 0.09 mm, 0.07 and 0.08 mm, or a diameter falling within any other suitable range of diameters.

In some embodiments, insulated conductor 102 includes insulating layer 102b configured to insulate conductor 102a. The insulating layer 102b may comprise any suitable insulating material, such as, for example, different types of fluoropolymer insulation. For example, the insulating layer 102b may comprise perfluoroalkoxy (PFA), polytetrafluoroethylene (PTFE), or perfluoroelastomer (PFE). In some embodiments, the insulating layer 102b has a diameter between 0.24 mm and 0.32 mm, 0.26 mm and 0.3 mm, 0.27 mm and 0.29 mm, or a diameter falling within any other suitable range.

In some embodiments, the conducting foil 106 comprises any suitable conducting or superconducting material, such as, for example NbTi, CuNi, BeCu, Cu, or stainless steel. In some embodiments, the conducting foil 106 may have a thickness between 0.01 mm and 0.04 mm, 0.015 mm and 0.035 mm, 0.02 mm and 0.03 mm, 0.023 mm and 0.028 mm, or a thickness falling within any suitable range of thicknesses.

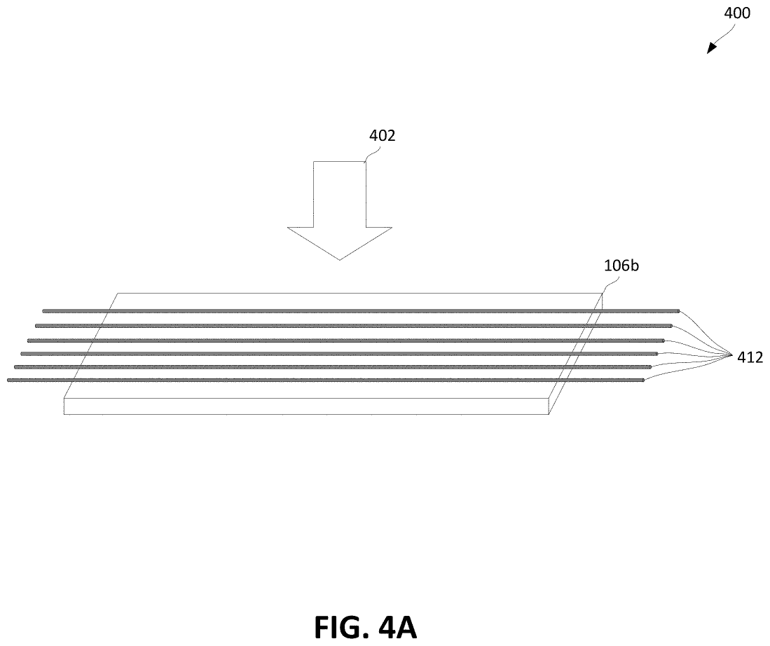

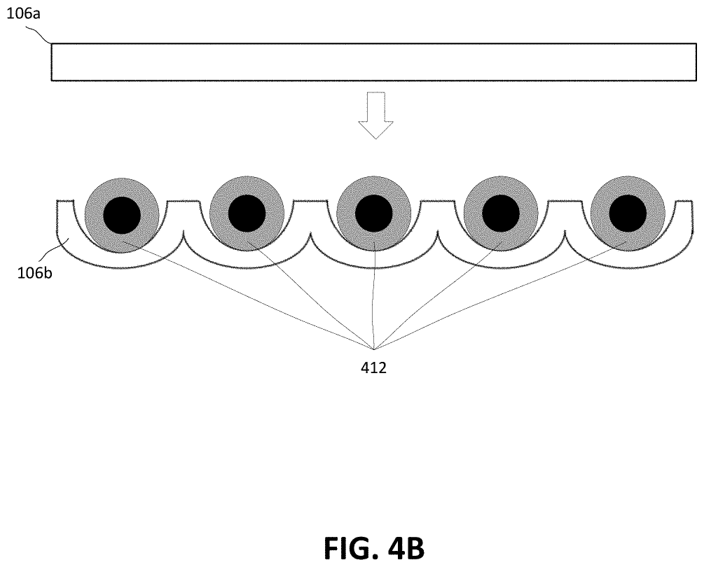

In some embodiments, the layers of conducting foil 106 are joined electrically and/or mechanically in regions 108a-d. Techniques for joining the conducting foil 106 to form cable 100 are described herein, including at least with respect to FIGS. 4A-6B. In some embodiments, the layers of conducting foil 106 are welded together. In some embodiments, the layers of conducting foil 106 are joined using conductive epoxy and/or conductive paint. In some embodiment, the layers of conducting foil 106 are joined by soldering metallic powders between the upper conducting foil 106a and lower conducting foil 106b.

It should be appreciated that the cable 100 of FIG. 1A is only a representative example of the cables described herein. While the cable 100 only shows three insulated conductors 102, the cables described herein may, in some embodiments, include between 1 and 100 insulated conductors, between 2 and 80 insulated conductors, or any suitable number of insulated conductors. Additionally, or alternatively, in some embodiments, the cables described herein may have any suitable length, as the techniques described herein are not limited in this respect.

Additionally, or alternatively, while cable 100 only shows one conductor per region enclosed by the conducting foil (e.g., conductor 102a in region 104), in some embodiments, a cable may include multiple conductors per enclosed region. For example, FIG. 1B shows a schematic diagram of a flexible shielded ribbon cable 120 having conductors 122a and 122b in the same enclosed region 124. Conductors 122a and 122b may be insulated using one or more insulating layer(s) 122c to form insulated conductors 122. While cable 120 shows two conductors per enclosed region, it should be appreciated that a cable may include any other suitable number of conductors per enclosed region, as aspects of the technology described herein are not limited in this respect.

Nonlimiting examples of flexible shielded ribbon cables include Maybell Flexlines and flexible shielded ribbon cables described by Smith et al. (“Flexible Coaxial Ribbon Cable for High-Density Superconductive Microwave Device Arrays,” IEEE Trans. on Appl. Supercond. 31, 1 (2020)), which is incorporated by reference herein in its entirety.

II. Flexible Shielded Ribbon Cables and Dilution Refrigeration Systems

In some embodiments, flexible shielded ribbon cables may be used in dilution refrigeration systems. FIG. 1C is a schematic diagram of a dilution refrigerator including flexible shielded ribbon cables 150, in accordance with some embodiments of the technology described herein. Flexible shielded ribbon cables 150 may include cable 100 in FIG. 1A and/or cable 120 in FIG. 1B.

It may be advantageous to include flexible shielded ribbon cables in a dilution refrigerator because they have low thermal load and are mechanically soft for low vibration transmission. Accordingly, the flexible shielded ribbon cables are capable of transporting signals from the low temperatures (e.g., liquid Helium temperatures) of the dilution refrigerator to room temperature. Furthermore, because of their flexibility and high channel density, the flexible shielded ribbon cables fit within the infrastructure of the dilution refrigerator. Examples of dilution refrigerators and their operation are described in U.S. Patent App. No. 63/219,795 entitled Integrated Dilution Refrigerators, filed Jul. 8, 2021, the entire disclosure of which is incorporated by reference herein in its entirety.

In addition to their utility in dilution refrigeration systems, flexible shielded ribbon cables may be useful for any system that requires thermal and/or vibrational isolation. Nonlimiting examples of such systems include space craft, systems with movable stages, systems with vibration tables, or any other suitable system, as aspects of the technology described herein are not limited in this respect.

III. Method for Manufacturing a Cable

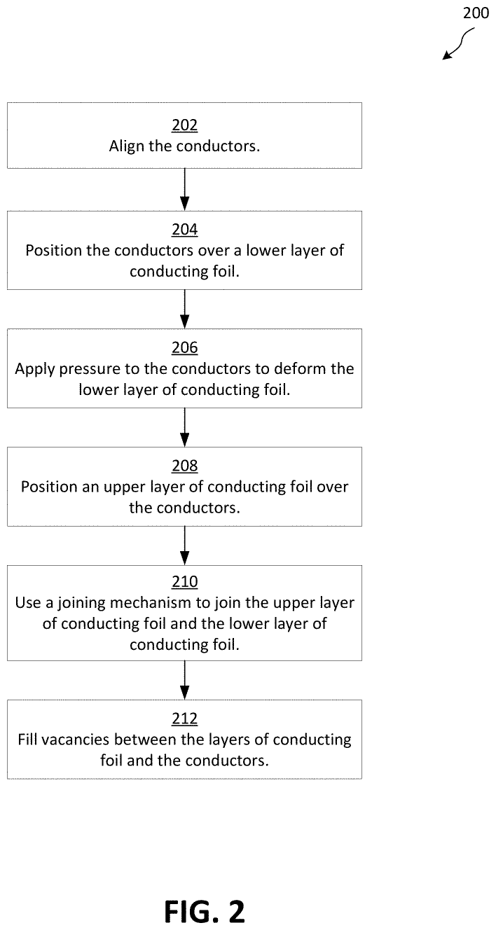

FIG. 2 is a flowchart of a method 200 for manufacturing a cable, in accordance with some embodiments of the technology described herein. The cable may include one or more conductors positioned between layers of conducting foil (e.g., an upper layer of conducting foil and a lower layer of conducting foil). In some embodiments, when the cable includes multiple conductors, the multiple conductors are separated from one another such as, for example, conductors 102a, 110, and 112 in FIG. 1A. Additionally, or alternatively, in some embodiments, when the cable includes multiple conductors, two or more of the conductors may be positioned in a same, enclosed region, such as, for example, conductors 122a and 122b shown in FIG. 1B.

In some embodiments, the conductors are separated from the layers of conducting foil by an insulating material. For example, the conductors may be insulated conductors. In some embodiments, method 200 may be used to manufacture cable 100, described herein including at least with respect to FIG. 1A, and/or cable 120, described herein including at least with respect to FIG. 1B.

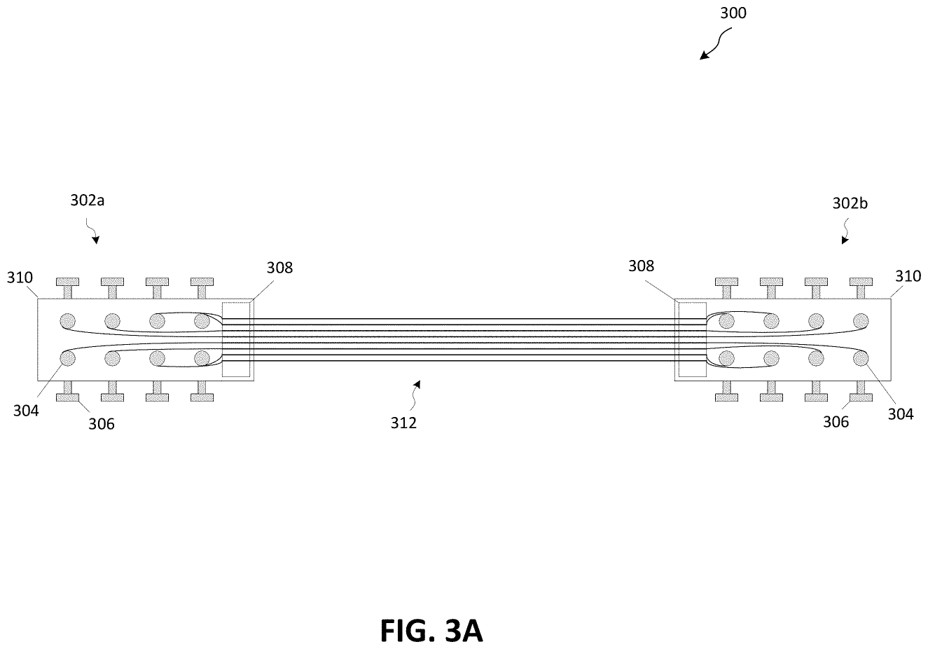

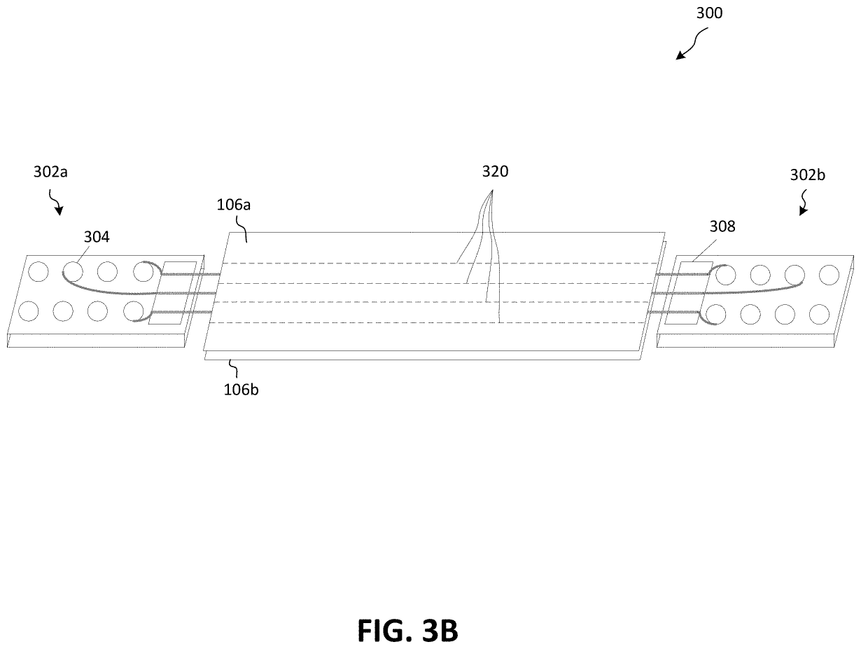

In some embodiments, act 202 of method 200 includes aligning the conductors. In some embodiments, aligning the conductors includes positioning and/or tensioning the conductors. For example, positioning the conductors may include positioning the conductors such that they are substantially parallel to one another or twisted around one another. Additionally, or alternatively, this may include positioning the conductors such that there is a specified separation between them. For example, the conductors may be separated by a distance or pitch between 0.5 mm and 3 mm. In some embodiments, act 202 includes maintaining a tension in the conductors. For example, this may include providing enough tension such that the conductors are taught (e.g., cannot move around during later manufacturing steps). Techniques for aligning conductors are described herein, including at least with respect to FIGS. 3A-3B, FIGS. 4A-4B, and FIG. 6A.

In some embodiments, act 204 includes positioning the aligned conductors over a lower layer of conducting foil. For example, the layer of conducting foil may include lower layer of conducting foil 106b, described herein including at least with respect to FIGS. 1A-1B.

In some embodiments, act 206 includes applying pressure to the conductors to deform the lower layer of conducting foil. For example, as pressure is applied, the conducting foil may form partially around the conductors. This may prevent the conductors from becoming displaced during later manufacturing steps. Techniques for deforming conducting foil are described herein including at least with respect to FIGS. 4A-4B.

In some embodiments, act 208 includes positioning an upper layer of conducting foil over the conductors and the lower layer of conducting foil. Accordingly, in some embodiments, as a result of act 208, the conductors may be positioned between the upper layer of conducting foil and the lower layer of conducting foil.

In some embodiments, the upper layer of conducting foil is deformed. For example, the upper layer of conducting foil may be deformed such that, when positioned over conductors at act 208, the conducting foil forms partially around the conductors. In some embodiments, deforming the upper layer of conducting foil includes positioning the conductors over the upper layer, and applying pressure to conductors. As pressure is applied, for example, the upper layer of conducting foil may form partially around the conductors. In some embodiments, deforming the upper layer of conductor foil is performed prior to act 204. For example, deforming the upper layer may be performed prior to act 204, but after act 202, so that the alignment of the conductors is the substantially the same during both the deformation of both the lower and upper layers of conducting foil.

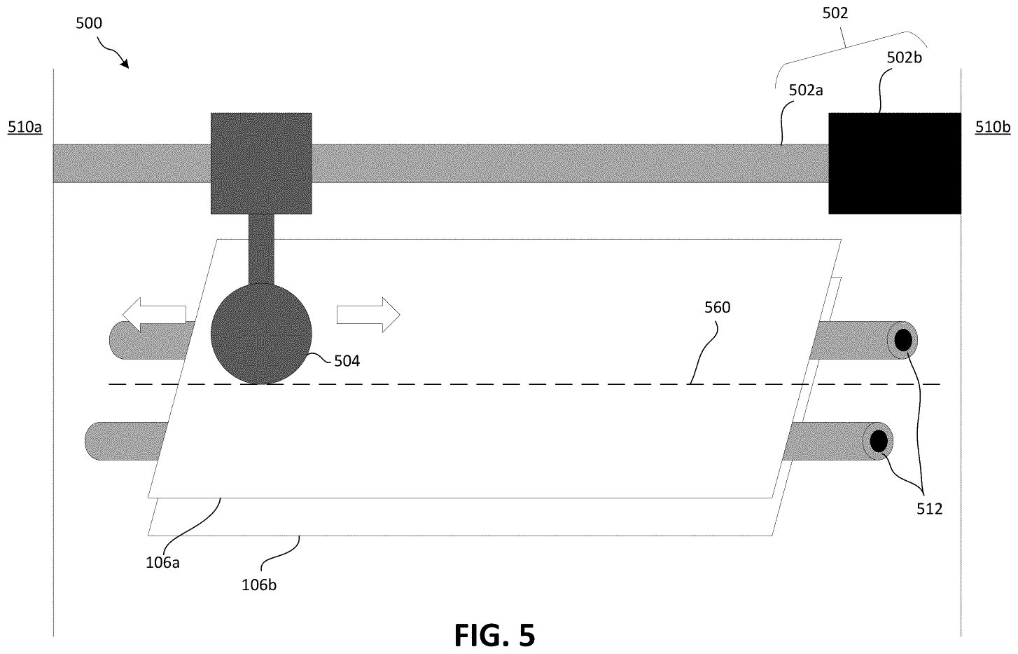

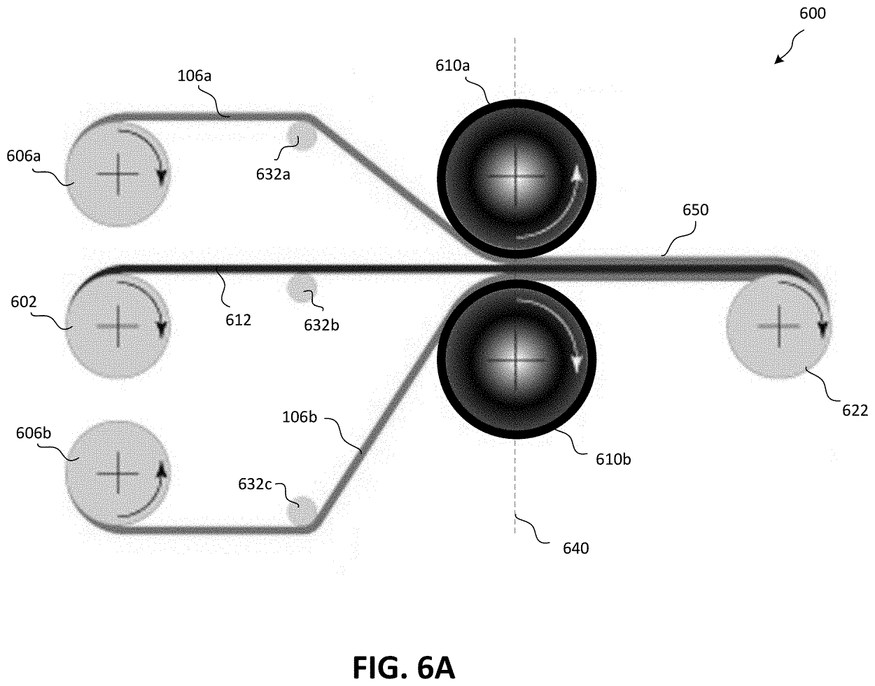

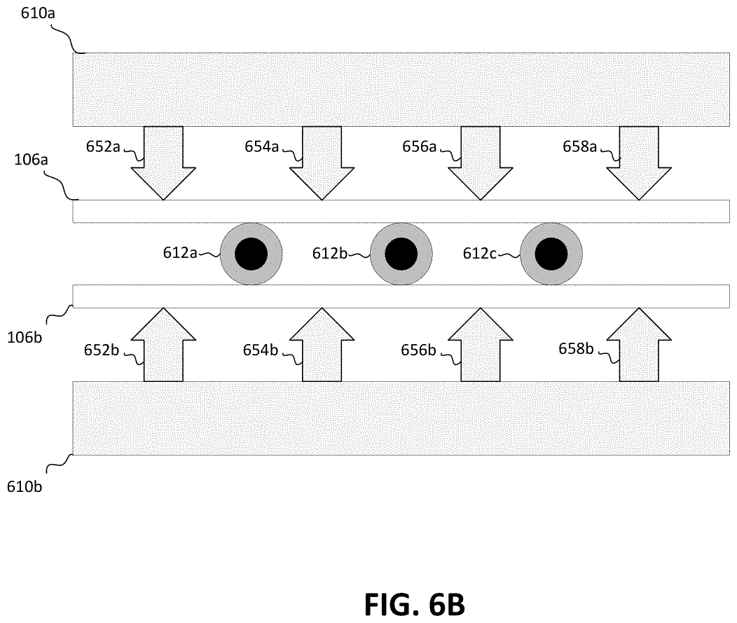

In some embodiments, act 210 includes using a joining mechanism to join the upper layer of conducting foil and the lower layer of conducting foil. In some embodiments, the joining mechanism is configured to join regions along the length of conductors positioned between the upper and lower layers of the conducting foil (e.g., in regions between conductors). In some embodiments, the joining mechanism includes welding the layers of conducting foil, lasering the layers of conducting foil, soldering metallic powder between the layers of conducting foil, depositing conductive epoxy between the layers of conducting foil, sonically bonding, and/or depositing conductive paint between the layers of conducting foil. In some embodiments, the joining mechanism moves relative to the cable materials. In some embodiments, the cable materials move relative to the joining mechanism. Techniques for joining layers of conducting foil are described herein including at least with respect to FIG. 5 and FIGS. 6A and 6B.

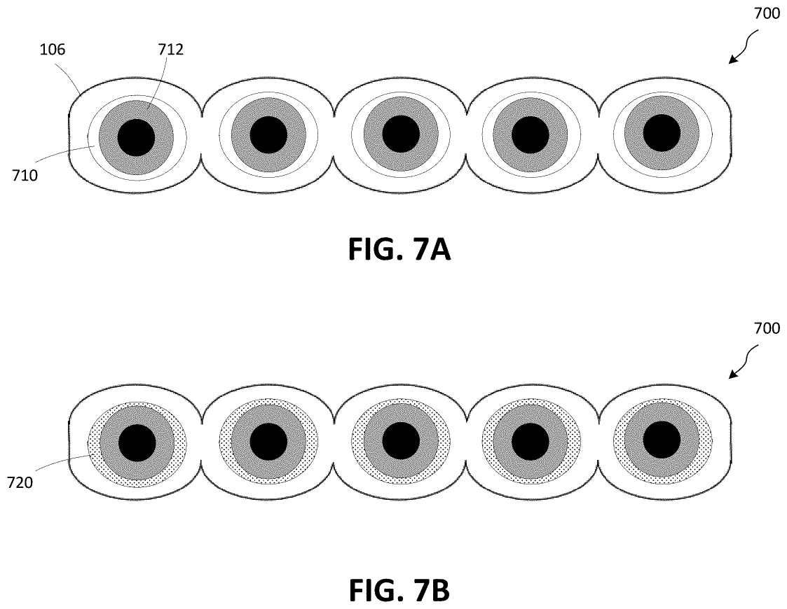

In some embodiments, act 212 includes filling vacancies between the layers of conducting foil and the conductors. This may be done during other acts of method 200 (e.g., during act 210). Additionally, or alternatively, the vacancies may be filled after the layers of conducting foil are joined at act 210. In some embodiments, epoxy, polymer resin, or any other suitable material may be used to fill vacancies in the cable. Techniques for backfilling a cable are further described herein including at least with respect to FIGS. 7A and 7B.

It should be appreciated that method 200 is not limited to the acts shown in FIG. 2. For example, method 200 may include one or more additional acts. Additionally, or alternatively, one or more of the acts shown in FIG. 2 may be omitted. For example, in some embodiments, acts 204-206 are omitted from method 200. As another example, in some embodiments, act 212 is omitted.

IV. Conductor Alignment

Conventional cable manufacturing techniques involve setting insulated conductors between two layers of conducting foil. The layers of conducting foil are then joined by forming micro spot welds along the length of each insulated conductor. Because they are loosely set in the conducting foil, the insulated conductors are at a risk of moving around during later stages of manufacturing (e.g., during welding), resulting in inconsistencies in the separation between each of the insulated conductor or conductors and the ground planes. Not only does this limit the density of insulated conductors in a cable, but it also varies the separation between each conductive surface. Due to this variability, the welding process requires careful attention to the placement of micro spot welds, resulting in inefficiencies in the welding process in general and in variable wire performance. The inventors have thus recognized that maintaining consistent separation between the conductive surfaces is paramount to the efficiency of the manufacturing process, quality of wire, and can increase the density of insulated conductors that can be included in a resulting cable.

Some embodiments provide for techniques for maintaining tension and separation between the insulated conductors during manufacturing. By maintaining such tension and separation, it is possible to maintain uniform spacing between the insulated conductors along the length of the resulting cable. This helps to improve the efficiency and the results of later manufacturing steps and allows for an increased density of insulated conductors in the resulting cable.

FIG. 3A and FIG. 3B are schematic diagrams of a system 300 for aligning and tensioning conductors, in accordance with some embodiments of the technology described herein. As shown in FIG. 3A, in some embodiments, the alignment system 300 is configured to align insulated conductors 312 between region 302a and region 302b. In some embodiments, the system 300 is configured to control the tension in each of the insulated conductors 312 and/or to maintain a separation between the insulated conductors 312. Insulated conductors 312 may include the insulated conductor 102 in FIG. 1A, the insulated conductors 122 in FIG. 1B, or any other suitable insulated conductors, as aspects of the technology described herein are not limited in this respect.

In some embodiments, system 300 includes one or more posts 304 in each region 302a, 302b. In some embodiments, a post 304 is configured to hold a portion of an insulated conductor 312 in either region 302a, 302b. For example, a portion of the insulated conductor 312 may be wrapped at least partially around, pinned, tied, and/or fixed by any suitable mechanism, using a post 304. In some embodiments, the posts 304 may be of any size, material, and/or shape that is suitable for fixing and/or holding a portion of the insulated conductor 312, as aspects of the technology described herein are not limited in this respect.

In some embodiments, posts 304 are mechanically coupled to pegs 306. In some embodiments, a peg 306 is configured to adjust the tension in an insulated conductor 312 aligned using system 300. For example, the peg 306 may be configured to turn post 304, resulting in the winding or unwinding of the insulated conductor 312. In some embodiments, pegs 306 may be adjusted manually (e.g., by hand) or automatically (e.g., by other components of system 300 (not shown). In some embodiments, system 300 may include a different, suitable mechanism for adjusting the tension in insulated conductors 312. For example, the posts 304 themselves may be turned manually or automatically.

In some embodiments, guides 308 control the spacing between the insulated conductors 312. In some embodiments, guides 308 each include one or more slots, ridges, loops, or any other suitable structure configured to separate the insulated conductors 312. For example, the guides 308 may be configured to maintain a separation of at least 0.8 mm, at least 1 mm, at least 1.2 mm, at least 1.5 mm, at least 2 mm, at least 2.5 mm, or at least 3 mm between the insulated conductors.

In some embodiments, the posts 304, pegs 306, and guides 308 are fixed to a structure 310 in each region 302a, 302b. In some embodiments, structures 310 are fixed during use. For example, the structures 310 may be fixed to control and maintain the tension in insulated conductors 312. In some embodiments, when not in use, structures 310 are moveable. For example, structures 310 may be moved to increase or decrease the separation between one another. This may be advantageous when manufacturing cables of different lengths.

In some embodiments, after aligning the insulated conductors 312 using system 300 upper conducting foil 106a and a lower conducting foil 106b are joined along the length 320 of the insulated conductors 312, as shown in FIG. 3B. In some embodiments, the layers are joined by welding (e.g., by continuous welding, friction welding, laser welding, or micro welding), by using a laser, by applying conductive paint between the layers, by applying conductive epoxy between the layers, by soldering metal powder between the layers, or using any other suitable joining mechanism, as aspects of the technology described herein are not limited in this respect. In some embodiments, soldering metal powder between the layers is advantageous because it is a low-cost production method and may produce hermetic seals for a vacuum interface. Techniques for joining layers of conducting foil are further described herein including at least with respect to FIGS. 5-6B.

Some embodiments provide for techniques for pre-processing the conducting foil to reduce movement of insulated conductors during later manufacturing steps. For example, FIG. 4A is a schematic diagram of a system 400 for deforming a conducting foil, in accordance with some embodiments of the technology described herein.

In some embodiments, the techniques include aligning the insulated conductors 412 along conducting foil 106b. Insulated conductors 412 may include the insulated conductor 102 in FIG. 1A, the insulated conductors 122 in FIG. 1B, or any other suitable insulated conductors, as aspects of the technology described herein are not limited in this respect.

Techniques for aligning insulated conductors 412 are described herein including at least with respect to FIGS. 3A-3B. In some embodiments, other suitable techniques are used to align the insulated conductors 412.

In some embodiments, after the insulated conductors 412 are aligned, a force 402 is applied to the insulated conductors and conducting foil 106b. In some embodiments, a press that moves perpendicular, or substantially perpendicular, to the conducting foil 106b is used to apply the force 402. In some embodiments, the insulated conductors 412 and conducting foil 106b are moved through one or more rollers that are configured to apply the force 402.

In some embodiments, prior to application of force 402, the conducting foil 106b is positioned over polymer or fluoropolymer. For example, conducting foil 106b may be positioned over PTFE, or any other suitable material.

Force 402, in some embodiments, deforms conducting foil 106b. For example, FIG. 4B shows a schematic diagram of the conducting foil 106b after it has been deformed.

In some embodiments, the deformed conducting foil 106b stabilizes and maintains alignment of the insulated conductors 412 during later manufacturing steps. FIG. 4B is a schematic diagram of a system for manufacturing a cable using the deformed conducting foil resulting from the system 400, in accordance with some embodiments of the technology described herein. For example, the insulated conductors 412 sit in the deformed lower conducting foil 106b while it is joined with upper conducting foil 106a. Techniques for joining layers of conducting foil are described herein including at least with respect to FIGS. 5-6B.

V. Joining Mechanisms

Conventional techniques for manufacturing fully welded cables are laborious, inefficient, and lead to inconsistent results. The techniques include joining the upper and lower conducting layers by forming micro spot welds along the length of the insulated conductors. However, because the welding tool and/or the cable materials are manually handled, there are often inconsistencies in forming the micro spots welds. For example, the position of the micro spot welds with respect to one another and/or with respect to the insulated conductors may be inconsistent. These inconsistencies can affect the impedance along the length of a cable, contributing to issues of impedance mismatch. Furthermore, these techniques are manual, laborious, and inefficient for high production output. The inventors have thus recognized and appreciated that using an automated, consistent joining mechanism can increase production efficiency and can produce repeatable conducting foil connections for impedance control.

FIG. 5 is a schematic diagram of a system 500 for joining layers of conducting foil, in accordance with some embodiments of the technology described herein. In some embodiments, system 500 includes a linear actuator 502 configured to control motion of a joining mechanism 504 relative to the layers of conducting foil 106a, 106b and insulated conductors 512, along axis 560.

Insulated conductors 512 may include the insulated conductor 102 in FIG. 1A, the insulated conductors 122 in FIG. 1B, or any other suitable insulated conductors, as aspects of the technology described herein are not limited in this respect.

In some embodiments, the linear actuator comprises a shaft 502a and a motor 502b. In some embodiments, the shaft 502a and the motor 502b are each coupled to a fixed structure (e.g., structure 510a and structure 510b), such that the linear actuator 502 is positioned at a specified height above the layers of conducting foil 106a, 106b. For example, the fixed structures 510a, 510b may include walls, posts, or any other suitable fixed structure. In some embodiments, the specified height depends on the size of the joining mechanism and/or the desired weld force. For example, for shorter joining mechanisms, the specified height may be relatively short, while for longer joining mechanisms, the specified height may be relatively long. Similarly, for a greater weld force, the specified height may be relatively short, while for a lesser weld force, the specified height may be relatively long.

In some embodiments, joining mechanism 504 is coupled to the shaft 502a of the linear actuator 502. In some embodiments, the length of the shaft 502a depends on the length of the cable being manufactured. For example, shaft 502a may span a length that is at least equivalent to the length of the cable being manufactured. Accordingly, the shaft 502a may be of any suitable length, as aspects of the technology are not limited in this respect.

In some embodiments, joining mechanism 504 includes a welding tool, a laser, a soldering tool, or a dispenser. In some embodiments, a welding tool includes one or more stationary electrodes, one or more oscillating point electrodes, one or more roller electrodes, a laser, and/or any other suitable welding tool, as aspects of the technology described herein are not limited in this respect. In some embodiments, the welding tool is configured to form one or more spot welds (e.g., micro spot welds) along axis 560 as the welding tool is moved using linear actuator 502. Additionally, or alternatively, a wheel head or laser may form a continuous seam and/or stitches (e.g., intermittent welds) along axis 560.

In some embodiments, a soldering tool includes any suitable type of press or soldering iron used to solder metallic powders between the upper conducting foil 106a and the lower conducting foil 106b. For example, the linear actuator may move the soldering tool or hot air gun, which is configured to heat melted metallic powder between the layers of conducting foil 106, along axis 560. In some embodiments, the melted metallic powder may be deposited on the lower conducting foil 106b, then the upper conducting foil 106a may be positioned and joined to the lower conducting foil 106b along axis 560. In some embodiments, the metallic powders may include any type of metallic powder suitable for soldering, such as, for example metallic powder formed of indium, silver, copper, or lead. In some embodiments, such metallic powders melt at lower temperatures than the melting point of plastics. Accordingly, the soldering tool may be used to join the layers of conducting foil 106 between insulated conductors 512, without interfering with the impedance of the insulation layer of the insulated conductors 512.

In some embodiments, a dispenser may hold conductive epoxy or conductive paint. The linear actuator 502 may move the dispenser between the layers of conducting foil 106, along axis 560. In some embodiments, the dispenser may include any suitable type of dispenser configured to deposit the conductive epoxy or conductive paint intermittently or continuously along axis 560. In some embodiments, the conductive epoxy or conductive paint may be deposited on the lower conducting foil 106b, then the upper conducting foil 106a may be joined to the lower conducting foil 106b along axis 560.

In some embodiments, prior to joining the layers of conducting foil using the techniques described with respect to FIG. 5, the insulated conductors 512 may be aligned to maintain tension and/or consistent separation between them. For example, the insulated conductors 512 may be aligned using any suitable techniques, such as the techniques described herein including at least with respect to FIGS. 3A-3B. Additionally or alternatively, prior to joining the layers of conducting foil, the lower conducting foil 106b may be deformed according to the techniques described herein including at least with respect to FIGS. 4A-4B.

Some embodiments provide for techniques for joining layers of conducting foil 106 by moving the materials for forming the cable with respect to a joining mechanism. FIG. 6A is a schematic diagram of a roll-to-roll system 600 for joining layers of conducting foil, in accordance with some embodiments of the technology described herein. In some embodiments, system 600 includes joining mechanism 610a-b, one or more rollers 606a-b, 602 configured to hold and/or tension materials prior to joining, a roller 622 configured to receive and/or tension the joined cable 650, and one or more other rollers 632a-c configured to tension, position, and/or hold materials throughout the joining process.

In some embodiments, rollers 606a, 606b are each configured to hold a roll of conducting foil. In some embodiments, the roller 606a is configured to rotate and unwind its roll of conducting foil as the upper conducting foil 106a is moved through system 600. Similarly, roller 606b is configured to rotate and unwind its roll of conducting foil as the lower conducting foil 106b is moved through system 600. In some embodiments, the torque and/or rotation speed of each roller 606a, 606b is adjusted to maintain tension in upper conducting foil 106a, lower conducting foil 106b, and/or resulting cable 650.

In some embodiments, rollers 632a, 632c are each configured to guide the layers of conducting foil as they move through system 600. For example, roller 632a may be configured to guide upper conducting foil 106a, while roller 632c may be configured to guide lower conducting foil 106b. In some embodiments, upper conducting foil 106a may wrap partially around or move tangentially to roller 632a, while lower conducting foil 106b may wrap partially around or move tangentially to roller 632c. In some embodiments, the rollers 632a, 632c are configured to rotate as the layers of conducting foil 106a, 106b move through system 600. The torque and/or rotation speed of each roller 632a, 632c may be adjusted to maintain tension in the upper conducting foil 106a, lower conducting foil 106b, and/or cable 650 as they move through system 600.

Insulated conductors 612 may include the insulated conductor 102 in FIG. 1A, the insulated conductors 122 in FIG. 1B, or any other suitable insulated conductors, as aspects of the technology described herein are not limited in this respect.

In some embodiments, roller 602 is positioned between roller 606a and 606b and is configured to hold a roll of insulated conductors 612. In some embodiments, roller 602 includes guides (not shown) configured to maintain a separation between insulated conductors 612. For example, the guides may include one or more slots, ridges, loops, or any other suitable structure for maintaining a separation between the insulated conductors 612. In some embodiments, roller 602 is configured to rotate and unwind the roll of insulated conductors to allow the insulated conductors 612 to move through system 600. The torque and/or rotation speed of roller 602 may be adjusted to maintain tension in the insulated conductors 612 and/or cable 650.

In some embodiments, roller 632b is configured to guide the insulated conductors 612 as they move through system 600. In some embodiments, the insulated conductors 612 wrap partially around or move tangentially to roller 632b. In some embodiments, the roller 632b is configured to rotate as the insulated conductors 612 move through system 600. The torque and/or rotation speed of roller 632b may be adjusted to maintain tension in the insulated conductors 612 and/or cable 650. Additionally or alternatively, roller 632b includes, in some embodiments, guides (not shown) configured to maintain a separation between insulated conductors. For example, the guides may include one or more slots, ridges, loops, or any other suitable structure for maintaining a separation between the insulated conductors 612.

In some embodiments, though not shown, the system 600 includes one or more rollers configured to deform the lower conducting foil 106b by applying a force to the insulated conductors 612 and the lower conducting foil 106b. Such rollers may be positioned prior to joining mechanism 610a-b. For example, techniques for deforming the lower conducting foil 106b are described herein including at least with respect to FIGS. 4A-4B.

In some embodiments, the joining mechanism 610a-b includes one or more welding tools configured to join upper conducting foil 106a and lower conducting foil 106b. For example, the joining mechanism 610a-b may include an upper joining mechanism 610a including one or more upper welding tools and a lower joining mechanism 610b including one or more lower welding tools. In some embodiments, a welding tool may include a stationary electrode, a laser, an oscillating point electrode, a roller electrode, ultra-sonic welder, a welding laser, and/or any other suitable welding tool.

Additionally or alternatively, the joining mechanism 610a-b includes one or more rollers configured to apply pressure to upper conducting foil 106a and lower conducting foil 106b. In some embodiments, prior to joining mechanism 610a-b, system 600 includes a soldering tool (not shown) configured to solder metallic powder onto either lower conducting foil 106b or upper conducting foil 106a. The joining mechanism 610a-b may then join the layers of conducting foil along the soldering line(s). In some embodiments, prior to joining mechanism 610a-b, system 600 includes a dispenser (not shown) configured to deposit conductive epoxy or conductive paint onto either lower conducting foil 106b or upper conducting foil 106a. The joining mechanism 610a-b may then join the layers of the conducting foil along the deposited epoxy or paint.

In some embodiments, the system 600 is configured such that insulated conductors 612 and the layers of conducting foil 106a, 106b are continuously rolled and joined using joining mechanism 610a, 610b. In some embodiments, the system 600 is configured such that insulated conductors 612 and the layers of conducting foil 106a, 106b are iteratively rolled and joined using joining mechanism 610a, 610b. For example, the conductors and layers of conducting foil may be rolled, then joined, then rolled, and so on.

FIG. 6B shows a cross section of system 600 along line 640, in accordance with some embodiments of the technology described herein. As shown, the upper joining mechanism 610a and lower joining mechanism 610b each include tools 652a-658a, 652b-658b. As described above, the tools 652a-658a, 652b-658b may include one or more welding tools or one or more rollers. In some embodiments, the tools 652a-658a of the upper joining mechanism 610a and the tools 652b-658b of the lower joining mechanism 610b form pairs. For example, the pair 652a and 652b is configured to join upper conducting foil 106a and lower conducting foil 106b at a region to the left of insulated conductor 612a. The pair 654a and 654b is configured to join upper conducting foil 106a and lower conducting foil 106b at a region between insulated conductor 612a and insulated conductor 612b. The pair 656a and 656b is configured to shape and/or join upper conducting foil 106a and lower conducting foil 106b in a region between insulated conductor 612b and insulated conductor 612c. The pair 658a and 658b is configured to join upper conducting foil 106a and lower conducting foil 106b in a region to the right of insulated conductor 612c.

Returning to FIG. 6A, after the upper conducting foil 106a, lower conducting foil 106b, and insulated conductors 612 have passed through joining mechanism 610a-b, they form cable 650. In some embodiments, roller 622 is configured to rotate and wind cable 650. For example, roller 622 may wind cable 650 such that it forms a roll of cable held on roller 622. The torque and/or speed of rotation of the roller 622 may be adjusted to maintain tension in cable 650, upper conducting foil 106a, lower conducting foil 106b, and/or insulated conductors 612.

By using rollers to move materials through the system 600, the system 600 may be used to manufacture cables of arbitrary length. For example, rollers 602, 606a-b may hold rolls of materials (e.g., conducting foil and insulated conductors) of any length, which may be passed through joining mechanism 610a-b to form cable 650 of any length.

VI. Back Filling Techniques

In some embodiments, the techniques include filling vacancies in the cable. This may provide for a cable that is more structurally sound and may produce hermetic seals that are important for cable placement at a vacuum interface.

FIG. 7A and FIG. 7B show schematic diagrams of a method for back filling a cable 700, in accordance with some embodiments of the technology described herein.

As shown, FIG. 7A shows cable 700 prior to back filling. Cable 700 includes vacancies 710. FIG. 7B shows cable 700 after back filling. As shown, vacancies 710 are filled with material 720.

In some embodiments, the back filling material 720 includes epoxy, polymer resin, or any other material suitable for back filling the cable 700.

In some embodiments, vacancies 710 in the cable are filled during or after production. For example, vacancies 710 may be filled during or after performance of the techniques described herein, including at least the techniques described herein with respect to FIGS. 5-6B.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

The terms “approximately,” “substantially,” and “about” may be used to mean within ±20% of a target value in some embodiments, within ±10% of a target value in some embodiments, within ±5% of a target value in some embodiments, within ±2% of a target value in some embodiments. The terms “approximately,” “substantially,” and “about” may include the target value.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

What is claimed is:

1. A system for joining an upper conducting foil and a lower conducting foil, the system comprising:
a joining mechanism configured to join the upper conducting foil and the lower conducting foil; and
a linear actuator configured to control motion of the joining mechanism with respect to the upper conducting foil and the lower conducting foil.

2. The system of claim 1, wherein the joining mechanism comprises a laser, a welding tool, a conductive epoxy, or a conductive paint.

3. The system of claim 1, wherein the joining mechanism comprises a soldering tool configured to solder a metallic powder between the upper conducting foil and the lower conducting foil.

4. The system of claim 1, wherein the joining mechanism is configured to join the upper conducting foil and the lower conducting foil between at least one first conductor and at least one second conductor.

5. The system of claim 4, wherein the at least one first conductor comprises multiple conductors or a single first conductor.

6. The system of claim 4, wherein the linear actuator is further configured to cause the joining mechanism to move between the at least one first conductor and the at least one second conductor.

7. The system of claim 6, wherein the linear actuator is further configured to cause the joining mechanism to move along a direction substantially parallel to the at least one first conductor and the at least one second conductor.

8. A method for joining an upper conducting foil and a lower conducting foil, the method comprising:
using a linear actuator to control motion of a joining mechanism with respect to the upper conducting foil and the lower conducting foil; and
joining the upper conducting foil and the lower conducting foil using the joining mechanism.

9. A system for manufacturing a cable comprising a plurality of insulated conductors positioned between an upper conducting foil and a lower conducting foil, the system comprising:
an electrode configured to join the upper conducting foil and the lower conducting foil in a region between insulated conductors of the plurality of insulated conductors; and
a plurality of rollers configured to position the upper conducting foil, the lower conducting foil, and the plurality of insulated conductors relative to the electrode.

10. The system of claim 9, wherein the electrode comprises a roller electrode, an oscillating point electrode, or a stationary electrode.

11. The system of claim 9, wherein the plurality of rollers comprises:
a first roller configured to position an upper roll of conducting foil, the upper roll of conducting foil comprising the upper conducting foil; and
a second roller configured to position a lower roll of conducting foil, the lower roll of conducting foil comprising the lower conducting foil.

12. The system of claim 11,
wherein the first roller is further configured to tension the upper roll of conducting foil, and
wherein the second roller is further configured to tension the lower roll of conducting foil.

13. The system of claim 9, further comprising:
an upper roll of conducting foil comprising the upper conducting foil; and
a lower roll of conducting foil comprising the lower conducting foil.

14. The system of claim 9, further comprising a plurality of guides configured to align the plurality of insulated conductors with respect to one another.

15. The system of claim 14, wherein aligning the plurality of insulated conductors with respect to one another comprises maintaining a specified distance between the insulated conductors of the plurality of insulated conductors.

16. The system of claim 14, wherein the plurality of guides is further configured to control a tension in the plurality of insulated conductors.

17. The system of claim 9, further comprising a heating element to anneal at least a portion of the cable.

18. The system of claim 9, wherein the plurality of rollers comprises:
one or more rollers configured to position the upper conducting foil, the lower conducting foil, and/or the plurality of insulated conductors.

19. The system of claim 18, wherein the one or more rollers are further configured to tension the upper conducting foil, the lower conducting foil, and/or the plurality of insulated conductors.

20. The system of claim 9, wherein the insulated conductors of the plurality of insulated conductors comprise at least one first insulated conductor and at least one second insulated conductor.
